(19) United States
(12) Patent Application Publication
(10) Pub. No.: US 2026/0258210 A1
(43) Pub. Date: Sep. 3, 2026

(54) HIGH THERMAL RESISTANCE PROPYLENE-BASED POLYMER TO PRODUCE BOPP FILM

(71) Applicant: Braskem S.A., Camaçari (BR)

(72) Inventors: Claudio Roberto Lima de Souza, São Paulo City (BR); Francisco Carlos Ruiz, São Paulo City (BR)

(73) Assignee: Braskem S.A., Camaçari (BR)

(21) Appl. No.: 19/383,380

(22) Filed: Nov. 7, 2025

Related U.S. Application Data
(60) Provisional application No. 63/718,339, filed on Nov. 8, 2024.

(51) Int. Cl. C08J 5/18; B29C 48/00; B29C 48/18; B29K 23/00; B29L 7/00; C08J 3/00

(52) U.S. Cl. CPC C08J 5/18; B29C 48/022; B29C 48/18; C08J 3/005; B29K 2023/12; B29K 2023/18; B29L 2007/008; C08J 2323/12; C08J 2423/20

(57) ABSTRACT

The present invention relates to a polymer composition comprising a propylene-based polymer and a 4-methyl-1-pentene-based polymer, to a multilayer film comprising an outer layer of the polymer composition and a sealing film comprising the multilayer film.

### FIELD OF THE INVENTION

This invention generally relates to a polymer composition, a multilayer film comprising the polymer composition as an outer layer and a laminated film comprising the multilayer film.

### BACKGROUND OF THE INVENTION

Biaxially oriented polypropylene (BOPP) is widely used in packaging applications because it is cheap, lightweight, transparent, and durable. However, conventional BOPP has limited thermal resistance, making it unsuitable for applications that require high-speed filling and/or sealing at high temperatures. To overcome these limitations, converters usually use Biaxially Oriented Polyethylene Terephthalate (BOPET) or Biaxially Oriented Polyamide (BOPA) films laminated to a sealing film, usually made of polyethylene to meet these requirements. However, the multilayer film becomes multi-material upon laminating BOPET or BOPA to a sealing film, which is mostly unsuitable for recycling as it mixes different types of resins.

The market is actively seeking mono-material films made from polyolefins that can replace BOPET and BOPA laminates in flexible packaging structures, seeking to guarantee a final product with better recyclability but maintaining its thermal resistance. To this end, there is a need to find suitable polymers or polymer compositions useful for imparting thermal resistance to BOPP. The polymer or polymer compositions must be cost-effective to ensure the economic feasibility of the solution over the others currently available. It is also advantageous that the BOPP film has good stiffness, which may be translated by a high stiffness (elasticity modulus) in the Transversal Direction (TD) and/or Machine Direction (MD) of the film.

There is also a need to propose BOPP structures that incorporate such polymer or polymer compositions so that the films have good thermal resistance, and stiffness and remain mono-material and, therefore, recyclable. Also, such a solution must be implemented to leverage the existing equipment technology, ensuring that there is no need to purchase new machinery or make significant adaptations to the current production setup.

### SUMMARY OF THE INVENTION

One aspect of the invention relates to a polymer composition comprising a propylene-based polymer; and a 4-methyl-1-pentene-based polymer.

Another aspect of the invention relates to a multilayer film comprising an outer layer comprising the polymer composition described herein and a core layer.

Another aspect of the invention relates to a laminated film, comprising the multilayer film described herein and a sealing layer.

### BRIEF DESCRIPTION OF DRAWINGS

FIG. 1 shows the DMA results for polymer compositions according to the present invention and prior art in a plot of Storage Modulus (MPa) vs. Temperature (° C.).

FIG. 2 shows the DMA results for polymer compositions according to the present invention and prior art in a plot Tan Delta vs. Temperature (° C.)

FIG. 3 shows an example of a tenter frame system for producing a multilayer film according to the present disclosure.

### DETAILED DESCRIPTION OF THE INVENTION

### The Polymer Composition

The disclosure provides a polymer composition comprising a propylene-based polymer; and a 4-methyl-1-pentene-based polymer. The polymer composition provided herein has good thermal resistance while maintaining cost-effectiveness over solutions available in the state of the art and it is easy to implement without need of machinery replacement.

### Propylene-Based Polymer

For the purposes of the present disclosure, the term “propylene-based” means that the polymer comprising at least 50% by weight of units derived from propylene. The propylene-based polymer according to the present disclosure comprises at least 50%, at least 51%, at least 55%, at least 60%, at least 65%, at least 70%, at least 75%, at least 80%, at least 85%, at least 90%, at least 95%, at least 96%, at least 97%, at least 98%, at least 99%, at least 99.5%, at least 99.9% or even 100% by weight of monomeric units derived from propylene, based on the total weight of the propylene-based polymer.

The propylene-based polymer according to the present disclosure may include propylene-based homopolymers produced from propylene. In other embodiments, the propylene-based polymers may include propylene-based copolymers produced from propylene and one or more comonomers, such as C₂-C₁₀ alpha-olefins (excluding propylene), for example ethylene, 1-butene, 1-hexene and 1-octene. Hence, the term “propylene-based polymer” includes both the homopolymers produced from propylene and copolymers produced from propylene and one or more comonomers, and any combination thereof. In one or more embodiments, the propylene-based polymer is a propylene-based homopolymer.

In one or more embodiments, the propylene-based polymer is a high-crystallinity propylene-based polymer. The crystallinity is directly correlated with the flexural modulus of a polymer. As the crystallinity of the polymer increases, the molecular chains become more ordered and closely packed. Such structure enhances intermolecular forces and therefore the stiffness and resistance to deformation, resulting in higher flexural modulus. For the purposes of the present invention, the term “high crystallinity” relates to a flexural modulus of at least 1700 MPa measured according to ASTM D790. The high-crystallinity propylene-based polymer has a flexural modulus of at least 1700 MPa, preferably from 1700 to 2500 MPa, preferably from 1700 to 2300 MPa, more preferably from 1700 to 2220 MPa, more preferably from 1700 MPa to 2000 MPa, even more preferably from 1800 MPa to 2000 MPa, measured according to ASTM D790.

In one or more embodiments, the propylene-based polymer has a melting point measured by DSC using ASTM D3418 of from 160° C. to 170° C., preferably from 162° C. to 167° C.

In one or more embodiments, the propylene-based polymer has a melt flow rate at 230° C./2.16 kg measured according to ASTM D792 from 0.5 to 10 g/10 min, preferably from 1 to 8 g/10 min, more preferably from 2 to 5 g/10 min.

In one or more embodiments, the propylene-based polymer has a Vicat softening temperature at 10 N measured according to ASTM D1525 of at least 150° C., preferably of at least 155° C., more preferably of at least 160° C.

### 4-Methyl-1-Pentene-Based Polymer

For the purposes of the present disclosure, the term “4-methyl-1-pentene-based polymer” means a polymer comprising at least 50% by weight of units derived from 4-methyl-1-pentene. The 4-methyl-1-pentene-based polymer according to the present disclosure comprises at least 50%, at least 51%, at least 55%, at least 60%, at least 65%, at least 70%, at least 75%, at least 80%, at least 85%, at least 90%, at least 95%, at least 96%, at least 97%, at least 98%, at least 99%, at least 99.5%, at least 99.9% or even 100% by weight of monomeric units derived from 4-methyl-1-pentene, based on the total weight of the 4-methyl-1-pentene-based polymer.

In one or more embodiments, the 4-methyl-1-pentene-based polymer is a copolymer including structural units derived from 4-methyl-1-pentene and one or more comonomers derived from ethylene or an α-olefin having 2 to 20 carbon atoms (4-methyl-1-pentene not included), preferably 2 to 8 carbon atoms, even more preferably 2 to 6 carbon atoms.

In one or more embodiments, the 4-methyl-1-pentene-based polymer has a flexural modulus measured according to ASTM D790 of at least 500 MPa.

In one or more embodiments, the 4-methyl-1-pentene-based polymer has a melt flow rate measured according to ASTM D1238 at 260° C./5 kg of at least 10 g/10 min, or at least 20 g/10 min.

In one or more embodiments, the 4-methyl-1-pentene-based polymer has a Vicat softening temperature at 10 N measured according to ASTMD1525 of at least 130° C., or at least 140° C., or at least 150° C.

In one or more embodiments, the 4-methyl-1-pentene-based polymer has a heat distortion temperature measured according to ASTM-D648 of at least 60° C., or at least 70° C., or at least 80° C.

In one or more embodiments, the 4-methyl-1-pentene-based polymer has a melting temperature measured by DSC using ASTM D3418 of at least 200° C. or at least 220° C. In one or more embodiments, the 4-methyl-1-pentene-based polymer has a melting temperature measured by DSC according to ASTM D3418 from 200° C. to 270° C., preferably 200° C. to 250° C., for example from 220° C. to 250° C.

### Polymer Composition

The thermal resistance of a polymer relates to its ability to maintain its physical and mechanical properties when exposed to elevated temperatures. A polymer exhibiting good thermal resistance retains structural integrity and functional performance over a broad temperature range, minimizing thermal-induced deterioration. Particularly, polymers with higher thermal resistance have lower storage modulus variation (decreasing) upon heating and tend to preserve storage modulus at higher temperatures, therefore maintaining stiffness and elasticity.

In one or more embodiments, the polymer composition has, in a Dynamic Mechanical Analysis (DMA) according to ASTM D4065, a storage modulus decreasing between 130° C. and 148° C. lower than 170 MPa, preferably lower than 165 MPa, even more preferably lower than 160 MPa. In one or more embodiments, the polymer composition has, in a Dynamic Mechanical Analysis according to ASTM D4065, a storage modulus decreasing between 130° C. and 148° C. lower than 70%, preferably lower than 60%, more preferably lower than 55%, even more preferably lower than 50%.

In one or more embodiments, the polymer composition has, in a Temperature vs. Tan Delta plot of a DMA analysis according to ASTM D4065, a first peak of Tan Delta in a temperature ranging from 30 to 35° C. In this context, the term “first peak” is to be understood as a first local or global maximum value in the Temperature vs. Tan Delta plot. The tan delta peak is also known as the glass transition temperature (Tg) of the material, at which the material passes from a glassy (rigid) state to a rubbery (flexible) state. In one or more embodiments, the polymer composition has a glass transition temperature (Tg) ranging from 30 to 35° C.

In one or more embodiments, the polymer composition comprises from 5 to 95% by weight of propylene-based polymer, preferably from 10 to 90% by weight of propylene-based polymer, based on the total weight of the polymer composition. In one or more embodiments, the polymer composition comprises a lower limit of 5%, 10%, 12%, 14%, 16%, 18%, 20% by weight of propylene-based polymer and an upper limit of 50%, 55%, 60%, 65%, 70%, 75%, 80%, 85%, 90%, 95% by weight of propylene-based polymer, based on the total weight of the polymer composition, wherein any lower limit may be combined with any upper limit. In one or more embodiments, the polymer composition comprises from 20 to 50% by weight of propylene-based polymer, based on the total weight of the polymer composition.

In one or more embodiments, the polymer composition comprises from 5 to 95% by weight of the 4-methyl-1-pentene-based polymer, preferably from 10 to 90% by weight of the 4-methyl-1-pentene-based polymer, based on the total weight of the polymer composition. In one or more embodiments, the polymer composition comprises a lower limit of 5%, 10%, 15%, 20%, 25%, 30%, 35%, 40%, 45%, 50% by weight of the 4-methyl-1-pentene-based polymer and an upper limit of 80%, 82%, 84%, 86%, 88%, 90%, 95% by weight of the 4-methyl-1-pentene-based polymer, based on the total weight of the polymer composition, wherein any lower limit may be combined with any upper limit. In one or more embodiments, the polymer composition comprises from 50 to 80% by weight of 4-methyl-1-pentene-based polymer, based on the total weight of the polymer composition.

In one or more embodiments, the polymer composition has at least two melting peaks on a DSC trace, one representing the propylene-based polymer and another one representing the 4-methyl-1-pentene-based polymer. One of the melting peaks in the DSC curve may range from 160° C. to 170° C., preferably from 162° C. to 167° C. Another melting peak in the DSC curve may range from 200° C. to 270° C., preferably from 220 to 250° C.

In one or more embodiments, the polymer composition has a melt flow rate at 230° C./2.16 kg measured according to ASTM D792 of from 0.1 to 10 g/10 min, preferably from 0.1 to 6 g/10 min, 0.5 to 9 g/10 min, preferably from 0.5 to 6 g/10 min, preferably from 1 to 7 g/10 min, preferably from 1 to 6 g/10 min.

### The Multilayer Film

In another aspect, the present disclosure relates to a multilayer film comprising (a) an outer layer comprising the polymer composition described herein, and (b) a core layer. The term “multilayer film” relates to a film comprising two or more layers. In one or more embodiments, the multilayer film is an oriented film, preferably a biaxially oriented film.

In one or more embodiments, the multilayer film of the present disclosure is a mono-material film. For the purposes of the present invention, the term “mono-material” means that the film comprises at least 90% by weight, at least 95% by weight, at least 99% by weight, at least 99.5% by weight, at least 99.9% by weight of polyolefins, or polyolefins compositions, such as ethylene-based polyolefins, propylene-based polyolefins, methyl pentene-based polyolefins, or any combination thereof. The terms “ethylene-based” and “methyl pentene-based” follow the same reasoning defined herein for “propylene-based”.

The formation of the multilayer film according to the present disclosure may use any method known in the art, such as coextrusion of polymers or polyolefins.

### Outer Layer

The outer layer functions as a thermal resistance layer and comprises the polymer composition defined herein. All above descriptions and all embodiments discussed in the above aspects relating to polymer composition described herein, such as the propylene-based polymer, the 4-methyl-1-pentene-based polymer, mechanical properties of the composition and polymers, and constitutive features of the polymer composition are applicable to this aspect of the invention relating to the outer layer of the multilayer film.

The outer layer composes up to 10% by weight of the total film. In one or more embodiments, the outer layer composes from 0.5% to 10% by weight of the multilayer film, preferably from 1% to 7% by weight, more preferably from 1% to 5% by weight, and even more preferably from 1% to 3% by weight of the multilayer film.

In one or more embodiments, the internal layer has a thickness ranging from 0.5 μm to 5 μm, preferably 1 μm to 3 μm, more preferably from 1.5 μm to 3 μm.

### Core Layer

The core layer is the main driver of the multilayer-film structure, composing at least 60% by weight of the total film. In one or more embodiments, the core layer composes at least 60% by weight, at least 70% by weight, at least 80% by weight, or at least 90% by weight of the film structure. In one or more embodiments, the core layer composes from 60% to 95% by weight of the multilayer film, preferably from 70% to 95% by weight, more preferably from 80% to 95% by weight, and even more preferably from 90% to 95% by weight of the multilayer film.

In one or more embodiments, the core layer has a thickness ranging from 10 to 50 μm, preferably 15 to 35 μm, more preferably from 15 μm to 30 μm.

In one or more embodiments, the composition of the core layer is proposed in a way that its stiffness and processability are balanced. The rigidity is important for the dimensional and shape stability of the film. However, the film should not be rigid to the point that becomes prone to cracking or breaking under stress and, therefore, challenging to be processed. To this end, in one or more embodiments the core layer has a flexural modulus measured according to ASTM D790 from 1400 to 2000 MPa, from 1500 to 2000 MPa, from 1400 to 1800 MPa or even from 1500 to 1800 MPa.

In one or more embodiments, the core layer comprises one or more propylene-based polymers. The one or more propylene-based polymers composing the core may include propylene-based homopolymers produced from propylene and/or propylene-based copolymers produced from propylene and one or more comonomers, such as C₂-C₁₀ alpha-olefins (excluding propylene). In one or more embodiments, the one or more propylene-based polymers are selected from propylene-based homopolymers.

When more than one propylene-based polymer is used, the amounts of each are designed to achieve the flexural modulus range necessary to balance stiffness and processability, within the range as defined herein for the core layer. For a polymer blend and in the context of the present disclosure, the flexural modulus of the blend can be considered a weighted average of the constituents of the blend. In one or more embodiments, the core layer comprises a medium crystallinity propylene-based polymer or a combination of a medium crystallinity propylene-based polymer with at least one high crystallinity propylene-based polymer. In one or more embodiments, the core layer comprises a medium crystallinity propylene-based polymer or a combination of a medium crystallinity propylene-based polymer with one high crystallinity propylene-based polymer For the purposes of the present invention, the term “medium crystallinity” relates to a flexural modulus measured according to ASTM D790A from 1300 to 1700 MPa. In one or more embodiments, the core layer comprises from 30 to 100% by weight of a medium crystallinity propylene-based polymer and from 0% to 70% of one or more high crystallinity propylene-based polymer.

### Internal Layer

In one or more embodiments, the multilayer film comprises an internal layer comprising one or more propylene-based homopolymers or copolymers. The internal layer composes up to 10% by weight of the total film. In one or more embodiments, the internal layer composes from 0.5% to 10% by weight of the multilayer film, preferably from 1% to 7% by weight, more preferably from 1% to 5% by weight, and even more preferably from 1% to 3% by weight of the multilayer film.

In one or more embodiments, the internal layer has a thickness ranging from 1 to 3 μm.

The internal layer may function as a treatment layer, a sealing layer or a thermal resistance layer.

For the purposes of the present disclosure, the treatment means changing the superficial tension of the treatment layer via corona, plasma, or flame treatment using methods known in the art. Treatments are to be performed when there is a need to laminate the multilayer film further with other layers, such as ink, coating, adhesives, or even metallization. When performing the treatment, the surface of the layer is degraded, promoting bonds to oxygen that increase its superficial tension and make it more suitable for bonding.

Lower crystallinity propylene-based polymers are particularly suitable to compose treatment layers as lower crystallinity is associated with easier and last-longing surface treatments. In one or more embodiments, the internal layer comprises one or more low-crystallinity propylene-based polymers. For the purposes of the present invention, the term “low crystallinity” relates to a flexural modulus measured according to ASTM D790 below 1300 MPa, preferably below 1000 MPa. In one or more embodiments, the internal layer has a flexural modulus measured according to ASTM D790 below 1300 MPa, preferably below 1000 MPa. In one or embodiments, the low crystallinity propylene-based polymer is a propylene-based copolymer comprising comonomers selected from C₂-C₁₀ alpha-olefins (excluding propylene), for example, ethylene, 1-butene, 1-hexene, 1-octane, or any combination thereof. In one or more embodiments, the low crystallinity propylene-based polymer is a propylene-based copolymer comprising a comonomer selected from ethene, 1-butene, 1-hexene, or any combination thereof. In one or more embodiments, the low crystallinity propylene-based polymer is a propylene-based terpolymer of ethene and 1-butene as comonomers, or a propylene-based copolymer of ethene as comonomer.

The internal layer may also function as a sealing layer, which is a low melting point layer capable of forming strong bonds between layers of the film upon heating. The sealing layer initiates melting before the other layers of the film to promote effective sealing without damaging the overall structure. One of the parameters important for heat sealability is the Seal Initial Temperature (SIT), which is the minimum temperature at which the sealing layer starts to melt and form a bond. In one or more embodiments, the internal layer has a Seal Initial Temperature (SIT) measured according to ASTM F2029 below 120° C., preferably below 110° C., preferably below 100° C.

In one or embodiments, the sealing layer is composed of one or more low crystallinity propylene-based polymer. In one or more embodiments, the low crystallinity propylene-based polymer is a propylene-based copolymer comprising comonomers selected from C₂-C₁₀ alpha-olefins (excluding propylene), for example, ethylene, 1-butene, 1-hexene, 1-octane, or any combination thereof. In one or more embodiments, the low crystallinity propylene-based polymer is a propylene-based copolymer comprising a comonomer selected from ethene, 1-butene, 1-hexene, or any combination thereof. In one or more embodiments, the low crystallinity propylene-based polymer is a propylene-based terpolymer of ethene and 1-butene as comonomers, or a propylene-based copolymer of ethene as comonomer.

In one or more embodiments, the multilayer film has a 2-layered structure comprising an outer layer and a core layer. In one or more embodiments, the multilayer film has a 3-layered structure comprising an outer layer, a core layer, and an internal layer preferably wherein the core layer is placed between the outer and the internal layers.

### Intermediate Layer

In one or more embodiments, the multilayer film comprises one or more intermediate layers. Intermediate layers give more versatility in the overall composition of the film as well as in the contribution of overall properties such as mechanical and thermal properties. The composition of the one or more intermediate layers may be the same or independently selected from each other.

In one or more embodiments, the intermediate layer has a thickness ranging from 1 μm to 10 μm, preferably 2 μm to 6 μm, more preferably from 3 μm to 6 μm.

In one or more embodiments, each intermediate layer composes from 0.5% to 10% by weight of the multilayer film, preferably from 1% to 7% by weight, more preferably from 1% to 5% by weight, and even more preferably from 1% to 3% by weight of the multilayer film.

Intermediate layers may be placed between the outer layer and core layer, or between the core layer and internal layer (when present), or both. In one or more embodiments, the multilayer film has a 3-layered structure comprising an outer layer, and intermediate layer, and a core layer. In one or more embodiments, the multilayer film has a 4-layered structure comprising an outer layer, a core layer, an intermediate layer, and an internal layer. In one or more embodiments, the multilayer film has a 5-layered structure comprising an outer layer, a first intermediate layer, a core layer, a second intermediate layer, and an internal layer.

In one or more embodiments, the intermediate layer comprises a high crystallinity propylene-based polymer having a flexural modulus measured according to ASTM D790 of at least 1700 MPa. The high-crystallinity propylene-based polymer has a flexural modulus of at least 1700 MPa, preferably from 1700 to 2500 MPa, preferably from 1700 to 2300 MPa, more preferably from 1700 to 2220 MPa, more preferably from 1700 MPa to 2000 MPa, even more preferably from 1800 MPa to 2000 MPa, measured according to ASTM D790.

In one or more embodiments, the one or more intermediate layers further comprises a 4-methyl-1-pentene-based polymer. All above descriptions and all embodiments discussed in the above aspects relating to the 4-methyl-1-pentene-based polymer described herein in the polymer composition section, such as composition, mechanical and thermal properties, are applicable to this aspect of the invention relating to the intermediate layer.

In one or more embodiments, the intermediate layer comprises a medium crystallinity propylene-based polymer or a combination of a medium crystallinity propylene-based polymer with a high crystallinity propylene-based polymer For the purposes of the present invention, the term “medium crystallinity” relates to a flexural modulus measured according to ASTM D790A from 1300 to 1700 MPa.

In one or more embodiments, the intermediate layer comprises a high crystallinity propylene-based polymer and a from 30 to 100% by weight of a medium crystallinity propylene-based polymer and from 0% to 70% of one or more high crystallinity propylene-based polymer.

In one or more embodiments, the one or more intermediate layers function as a thermal resistance layer and comprises the polymer composition defined herein. All above descriptions and all embodiments discussed in the above aspects relating to polymer composition described herein, such as the propylene-based polymer, the 4-methyl-1-pentene-based polymer, mechanical properties of the composition and polymers, and constitutive features of the polymer composition are applicable to this aspect of the invention relating to the one or more intermediate layers of the multilayer film.

In one or more embodiments, the one or more intermediate layers function as a structuring layer and may have the same composition as proposed for the core layer defined herein. All above descriptions and all embodiments discussed in the above aspects relating to core layer described herein, such as the flexural modulus ranges and balances, propylene-based polymers and composition of the layer and constitutive features of the polymer composition in the core layer are applicable to this aspect of the invention relating to the one or more intermediate layers of the multilayer film.

### The Laminated Film

In a further aspect, the present disclosure relates to a laminated film, comprising the multilayer film described herein and a sealing film.

The sealing film is a secondary monolayer or multilayer film, preferably a polyethylene film or polypropylene film. The film may be non-oriented, mono-oriented or biaxially oriented. The sealing film comprises a low melting point layer capable of forming strong bonds between layers of the film upon heating (i.e., a sealing layer). The sealing layer initiates melting before the other layers of the film to promote effective sealing without damaging the overall structure. One of the parameters important for heat sealability is the Seal Initial Temperature (SIT), which is the minimum temperature at which the sealing layer starts to melt and form a bond. In one or more embodiments, the sealing layer of the sealing film has a Seal Initial Temperature (SIT) measured according to ASTM F2029 below 120° C., preferably below 110° C., preferably below 100° C. The sealing layer may be composed of an ethylene-based copolymer, or a propylene-based copolymer, or a propylene-based terpolymer.

The number of layers of the sealing film is not particularly limited. The sealing film may comprise from 2 to 100 layers, from 2 to 50 layers, from 2 to 15 layers, from 2 to 11 layers, at least one of them being a sealing layer. The layers of the sealing film, especially the layers that are not the sealing layer, can also be responsible for giving a more robust structure to the sealing film or provide barrier properties and, consequently, to the laminated film. The sealing film may have a thickness of up to 200 μm, up to 150 μm, up to 100 μm, and it is usually thicker than the multilayer film of the present disclosure.

In one or more embodiments, the sealing film is mono-material. In one or more embodiments, the laminated film is mono-material. In one or more embodiments, the multilayer film, the sealing film, and the laminated film are mono-material.

In one or more embodiments, the laminated film is produced by a lamination step where the multilayer film of the present disclosure and the sealing film are laminated together. When lamination processes are used, adhesive layers may be applied between the multilayer film and the sealing film to promote adhesion between them.

### Preparing the Multilayer Film

The formation of the multilayer film according to the present disclosure may use any method known in the art, such as coextrusion. The multilayer films may be formed, for example, in a two-step process, where a film is first formed, such as through melt extrusion casting, which is cooled and then reheated to a softened state where it is deformable (below melting temperature) and stretched in one or more directions. In one or more embodiments, the method of producing the multilayer film comprises co-extruding the outer and core layers (i.e., the polymer or polymer composition that forms each layer) to produce a casting having adjacent layers, optionally with one or more internal and/or intermediate layers to form a casting having the desired multilayer structure.

In one or more embodiments, the method of producing the multilayer film further comprises the step of heating while stretching the polymer substrate in both longitudinal and transverse directions to produce an oriented film. In a preferred embodiment, the multilayer film is produced using a tenter frame process.

The manufacture of the multilayer film may use a tenter frame process in which the components of each layer are initially mixed and melted within an extruder. The temperature within the extruder may be selected to ensure melting of the components. The extrudate is cast to form a cast film (or flat film) which is then cooled before any reheating process is begun. After cooling, the film is then reheated, and stretching is begun. The temperature during the stretching phase can vary and may decrease as the stretching process continues. Once stretching in the machine direction is complete, the film is annealed. This maintains the machine direction oriented (MDO) film structure for the transversal direction (TD_stretch). Reheating for the second stretching phase is carried out and the temperature can vary during the stretching phase. Finally, the film is allowed to cool.

One or more embodiments for manufacturing films may include the following steps. First, the resin may be melted and homogenized in an extruder, and resulting melt, may be formed into a casting or cast film which is cooled to a temperature less than 70° C. The casting is then heated to temperatures such as between 8° and 110° C., and stretched, such as on a tenter frame, in a machine direction at a ratio between 1:3 to 1:10. It is noted that the indicated temperature may be the temperature at the start of the stretching process and may vary as the stretching process goes on. The MDO-stretched film may then be annealed at temperatures between 5° and 90° C., and then reheated to temperatures between 10° and 150° C. for stretching in transverse direction at a ratio between 1:5 to 1:10. Again, it is noted that the indicated temperature may be the temperature at the start of the stretching process and may vary as the stretching process goes on.

As mentioned above, film production in accordance with the present embodiments can be of any suitable technique including the tenter processing. In tenter frames, the polymer or polymers used to make the film are melted and then passed through an extruder to a slot die mechanism after which it is passed over a first roller, characterized as a chill roller, which tends to solidify the film. The film is then oriented by stressing it in a longitudinal direction, characterized as the machine direction, and in a transverse direction to arrive at a film which can be characterized in terms of orientation ratios, sometimes also referred to as stretch ratios, in both longitudinal and transverse directions.

The machine direction orientation may be accomplished through the use of two sequentially disposed rollers, the second or fast roller operating at a speed in relation to the slower roller corresponding to the desired orientation ratio. This may alternatively be accomplished through a series of rollers with increasing speeds, sometimes with additional intermediate rollers for temperature control and other functions. After the film has been stressed in the machine direction, it is again cooled and then pre-heated and passed into a lateral stressing section, for example, a tenter frame mechanism, where it is again stressed, this time in the transverse direction. Orientation in the transverse direction may be followed by an annealing section. Subsequently, the film is then cooled and may be subjected to further treatment, such as a surface treatment (for example corona treatment or flame treatment).

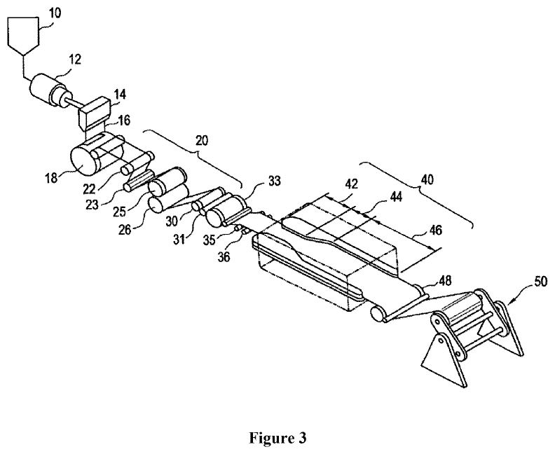

FIG. 3 illustrates a tenter frame that may be employed in producing multilayer film in accordance with the present disclosure. In FIG. 3, a source of molten polymer is supplied from a heated hopper 10 to an extruder 12 and from there to a slot die 14 which produces a flat, relatively thick film 16 at its output. Film 16 is applied over a chill roller 18, and it is cooled to a suitable temperature. The film is drawn off the chill roller 18 to a stretching section 20 to which the machine direction orientation occurs by means of idler rollers 22 and 23 that lead to preheat rollers 25 and 26.

As the film is drawn off the chill roller 18 and passed over the idler rollers, it is cooled to a temperature of less than 70° C., such as between 3° and 60° C. In stretching the film in the machine direction, it is heated by preheat rollers 25 and 26 to an incremental temperature increase of about 80-110° C. and is oriented by fast roller 31 operating at a suitable speed greater than that of the preheat rollers in order to orient the film in the machine direction.

As the oriented film is withdrawn from the fast roller 31, it is passed over a roller 33 at room temperature conditions. From here it is passed over rollers to a lateral stretching section 40 where the film is oriented by stretching in the transverse direction. The section 40 includes a preheat section 42 comprising a plurality of tandem heating rollers (not shown) where it is reheated to a temperature within the range of 100-150° C. From the preheat section 42 of the tenter frame, the film is passed to a stretching or draw section 44 where it is progressively stretched by means of tenter clips (not shown) which grasp the opposed sides of the film and progressively stretch it laterally until it reaches its maximum lateral dimension. The concluding portion of the lateral stretching phase includes an annealing section 46, such as an oven housing, where the film is heated at a temperature within the range of 50-90° C. for a suitable period in time. The annealing time helps control certain properties, and increased annealing is often specifically used to reduce shrinkage.

The film is then withdrawn from the tenter frame and passed over a chill roller 48 where it is reduced to a temperature of less than about 50° C. and then applied to take-up spools on a take up mechanism 50. Typically, the initial orientation in the machine direction is carried out at a somewhat lower temperature than the orientation in the lateral dimension. For example, the film may be stretched in the machine direction at a temperature of about 90° C. and stretched in the lateral dimension at a temperature of 120° C.

During the biaxially stretching, the stretching may have a total stretching ratio in the machine direction ranging from 1:3 to 1:10, and a total stretching ratio in the transverse direction ranging from 1:5 to 1:10. Further, the biaxially stretching may have a machine direction speed ranging from 250 to 750 mm/s.

In one or more embodiments, the stretching ratio in the machine direction may have a lower limit of any of 1:3 or 1:4 to an upper limit of any of 1:7, 1:8, or 1:10, where any lower limit can be used in combination with any upper limit. In one or more embodiments, the stretching ratio in the transverse direction may have a lower limit of any of 1:5 or 1:55 to an upper limit of any of 1:7, 1:9, or 1:10, where any lower limit can be used in combination with any upper limit. Further, in particular embodiments, the MD stretch ratio may be less than the TD stretch ratio.

### EXAMPLES

The following examples are for illustrative purposes only and are not intended to limit, in any way, the scope of the present invention.

### Example A—Polymer Compositions

Different polymer compositions were produced with varying amounts of a polypropylene-based polymer (PP1) and a 4-methyl-1-pentene-based polymer (PMP1) using a conventional melt blending extrusion in a twin-screw extruder. For the melt blending extrusion, it is used a temperature of around 30-50° C. above the melting point of the components of the blend, particularly the one with higher melting temperature. A 100% PP1 comparative sample (CE2) was subjected to the same melt extrusion process. The polymers used in the analysis are summarized in Table 1 and each polymer composition is summarized in Table 2. PP1 is a propylene-based homopolymer, and PMP1 is a 4-methyl-1-pentene-based polymer.

The properties of PP1 were measured as follows: MFR according to ASTM D1238 (230° C./2.16 kg), density according to ASTM D792, flexural modulus according to ASTM D790, melting temperature according to ASTM D3418, Vicat softening temperature at 10N according to ASTM D1525. PP1 has a proportional cost of 1X US$/KG.

The properties of PMP1 were measured as follows: MFR according to ASTM D1238 (260° C./5 kg), density according to ASTM D1505, flexural modulus according to ASTM D790, melting temperature according to ASTM D3418, Vicat softening temperature at 10N according to ASTM D1525, heat distortion temperature according to ASTM D648.PMP1 has a proportional cost of around 9.5X US$/KG.

TABLE 1
Polymers properties

| | | | | | Vicat | Heat |
|---|---|---|---|---|---|---|
| | | | | Melting | Softening | Distortion |
| | | | Flexural | Temper- | Temper- | Temper- |
| | MFR | Density | Modulus | ature | ature | ature |
| | (g/10 min) | (kg/m³) | (MPa) | (° C.) | (° C.) | (° C.) |
| PP1 | 3.5 | 905 | 1800 | 164 | 160 | — |
| PMP1 | 25 | 833 | 1050 | 228 | 164 | 100 |

TABLE 2
Polymer compositions

| Polymer | PP1 | PMP1 | Proportional |
|---|---|---|---|
| composition | (wt. %) | (wt. %) | Price US$/KG |
| CE1 | 0 | 100 | 9.50 |
| CE2 | 100 | 0 | 1.00 |
| E1 | 95 | 5 | 1.43 |
| E2 | 80 | 20 | 2.70 |
| E3 | 70 | 30 | 3.55 |
| E4 | 50 | 50 | 5.25 |
| E5 | 20 | 80 | 7.80 |

### Example B—Dynamic Mechanical Analysis and Thermal Resistance

The second route explored was to PP1 with different concentrations of PMP1 to increase the thermal resistance of the material. The heat resistance is analyzed by DMA according to ASTM D4065, where the storage modulus is evaluated over a temperature range of −50 to 150° C. The results are shown in FIG. 1. In this analysis, the heat resistance is translated as the ability of the grade to preserve its storage modulus between the temperatures of 130° C. and 148° C., and the variation between these two temperatures was evaluated for the polymer compositions and comparative examples. The results are summarized in Table 4.

The results show that polymer compositions according to the present disclosure had a storage modulus decreasing between 130° C. and 148° C. lower than 170 MPa, showing good thermal resistance.

TABLE 3
Storage modulus variation between 130 and 148° C.

| | Storage Modulus | Storage Modulus | Variation | Variation |
|---|---|---|---|---|
| | @ 130° C. (MPa) | @ 148° C. (MPa) | (MPa) | (%) |
| CE1 | 160 | 118 | 42 | 26.3 |
| E5 | 133 | 85 | 48 | 36.3 |
| E4 | 146 | 74 | 72 | 49.2 |
| E3 | 218 | 107 | 111 | 51.1 |
| E1 | 273 | 105 | 167 | 61.4 |
| CE2 | 303 | 105 | 198 | 60.9 |

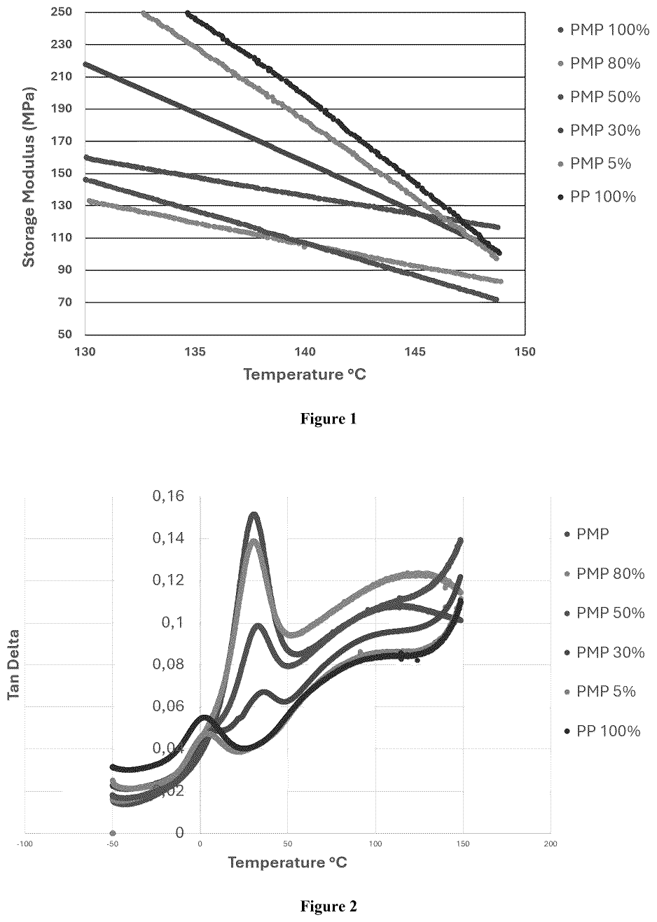

The variation of Loss factor (tan δ—i.e., the ratio between Loss Modulus E″ and Storage Modulus E′−E″/E′) was also evaluated in function of temperature. The results are shown in FIG. 2. For the polymer compositions according to the present invention, it is possible to see a peak value for tan δ (Tg) between 3° and 35° C.

1. A polymer composition comprising
a. a propylene-based polymer; and
b. a 4-methyl-1-pentene-based polymer.

2. The polymer composition of claim 1, wherein the propylene-based polymer is a high crystallinity propylene-based polymer having a flexural modulus measured according to ASTM D790 of at least 1700 MPa.

3. The polymer composition of claim 1, wherein the polymer composition has, in a Dynamic Mechanical Analysis according to ASTM D4065, a storage modulus decreasing between 130° C. and 148° C. lower than 170 MPa.

4. The polymer composition of claim 1, comprising from 5 to 95% by weight of propylene polymer and from 5 to 95% by weight of 4-methyl-1-pentene-based polymer, based on the total weight of the polymer composition.

5. The polymer composition of claim 1, wherein the propylene-based polymer has a melting temperature measured by DSC according to ASTM D3418 from 162° C. to 167° C.

6. The polymer composition of claim 1, wherein the polymer composition has two melting temperatures on a DSC trace.

7. (canceled)

8. (canceled)

9. The polymer composition of claim 1, wherein the propylene-based polymer has a Vicat softening temperature at 10 N measured according to ASTM D1525 of at least 150° C.

10. The polymer composition of claim 1, wherein the propylene-based polymer is a polypropylene homopolymer.

11. The polymer composition of claim 1, wherein the 4-methyl-1-pentene-based polymer is a copolymer including structural units derived from 4-methyl-1-pentene and one or more comonomers derived from ethylene or an α-olefin having 3 to 20 carbon atoms (4-methyl-1-pentene not included).

12. The polymer composition of claim 1, wherein the 4-methyl-1-pentene-based polymer has a flexural modulus measured according to ISO 178 of at least 500 MPa.

13. The polymer composition of claim 1, wherein the 4-methyl-1-pentene-based polymer has a melt flow rate at 260° C./5 kg of at least 20 g/10 min.

14. The polymer composition of claim 1, wherein the 4-methyl-1-pentene-based polymer has a Vicat softening temperature at 10 N measured according to ISO 306 of at least 140° C.

15. The polymer composition of claim 1, wherein the 4-methyl-1-pentene-based polymer has a heat distortion temperature measured according to ISO 75 of at least 70° C.

16. The polymer composition of claim 1, wherein the 4-methyl-1-pentene-based polymer has a melting temperature measured by DSC of at least 220° C.

17. A multilayer film comprising:
a. an outer layer comprising the polymer composition according to claim 1; and
b. a core layer.

18. The multilayer film of claim 17, wherein the core layer has a flexural modulus measured according to ASTM D790 from 1300 to 1700 MPa.

19. (canceled)

20. (canceled)

21. (canceled)

22. (canceled)

23. (canceled)

24. (canceled)

25. (canceled)

26. (canceled)

27. (canceled)

28. A laminated film, comprising
a. the multilayer film of claim 16, and
b. sealing film
